(19) United States
(12) Patent Application Publication
(10) Pub. No.: US 2025/0089934 A1
(43) Pub. Date: Mar. 20, 2025

(54) Method of Roasting a Cooking Product and Cooking Appliance

(71) Applicant: RATIONAL International AG, Heerbrugg (CH)

(72) Inventors: Diego HINCAPIE OCAMPO, Heerbrugg (CH); Reinhard WASSMUS, Heerbrugg (CH); Elvis HALIMANOVIC, Heerbrugg (CH); Kevin SPAHLHOLZ, Heerbrugg (CH); Florian LOEW, Heerbrugg (CH)

(21) Appl. No.: 18/889,037

(22) Filed: Sep. 18, 2024

(30) Foreign Application Priority Data
Sep. 18, 2023 (DE) 10 2023 125 212.7

(51) Int. Cl. A47J 36/32; A23L 5/10; A47J 37/06; H05B 3/68

(52) U.S. Cl. CPC A47J 36/32; A23L 5/15; A47J 37/0676; H05B 3/68; H05B 2203/005

(57) ABSTRACT

A cooking appliance on a contact heating surface of which a cooking product is roasted, provides that after placing a cooking product to be roasted onto the contact heating surface, the cooking product is recognized by an electronic detection device using a sensor system, and an automatic signaling that the cooking product needs to be moved, for example needs to be turned, is given to an operator after the automatic cooking.

### TECHNICAL FIELD

The disclosure relates to a method of roasting a cooking product and to a cooking appliance itself.

### BACKGROUND

The method is used to roast a cooking product using cooking appliances having a contact heating surface on which a cooking product to be roasted is placed. One example of such a cooking appliance is a cooking appliance having a pan, the pan bottom of which forms the contact heating surface. A further example is a plate-like roasting surface.

Furthermore, the disclosure relates to a cooking appliance itself, which has a control unit for executing the method described below.

Today's professional cooking appliances are able to perform cooking in a fully automated manner. Developments are underway to visually monitor the cooking product via sensor systems and accordingly to adjust the heating energy to the cooking process and the current state of the cooking product with regard to the desired target state.

The disclosure provides a method which simplifies cooking even further.

### SUMMARY

To this end, the disclosure provides the following steps:
determining a cooking product to be roasted placed onto the contact heating surface by means of at least one sensor system located above the contact heating surface and an electronic detection device connected thereto,
providing the cooking product with an identifier upon initial placement, which is stored in terms of control,
roasting the cooking product by the supply of heat via the contact heating surface, a control unit of the cooking appliance controlling the amount of the supplied heat in accordance with a cooking product-specific cooking path provided in a control unit as a function of the determined cooking product,
tracking the position of the cooking product via the sensor system during roasting, and
issuing at least one signal to an operator via the control unit, that the cooking product needs to be moved.

Upon initial placement, the cooking product is automatically provided in the control unit with an individual identifier which is stored in terms of control. The identifier is a digital characteristic and unique label for the cooking product, in other words a digital signature for the individual cooking product, which is assigned, stored and used by the control unit. The position of the cooking product is then tracked via the sensor system during roasting, for example permanently, so that the cooking product continues to be recognized even during or after a shifting thereof. A cooking product is individualized, for example, using the geometric data thereof such as the contour and/or color data. This information, which also changes in the course of the cooking method, can also be used to monitor the cooking process.

The method according to the disclosure is characterized in that the cooking path, which runs in the control unit, is not only adjusted and controlled using the visual data of the cooking product obtained from the sensor system, but that the operator also receives a signal that cooking product needs to be moved.

The operator may be a person or also a mechanical manipulator, e.g. a freely programmable, multi-axis operating unit.

Optionally, the method provides to check whether the correct one of several pieces of cooking product has been turned. If this has not been the case, a warning signal could be issued, or if the correct one has been turned, an ‘OK’ signal could be issued. These signals could be optical and/or acoustic signals.

Furthermore, the method may be designed so as to reduce the heating power after chopping the cooking product on the heating zones on which the chopped cooking product is located.

The method according to the disclosure may also be operated such that when the cooking product is moved or chopped without being requested to do so, the heating power is adjusted and/or heating zones are switched on or off (e.g. if a cooking product has been shifted to another heating zone). If, for example, a cooking product is shifted to a heating zone with a lower temperature for so-called “poaching”, this is recognized in an optical manner.

With the method according to the disclosure, it is achieved that the cooking product is not only able to reach its optimum degree of cooking via a supply of heat, but that it is also moved at the right time, i.e. for example that it is turned, removed, chopped, further cooking product is added or that the cooking product is moved on the contact heating surface, for example to heating zones having a higher or lower temperature.

As already indicated, the signal may be a signal signaling the end of the roasting process for the corresponding cooking product.

The term “cooking product” refers not only to a single cooking product, but also to several pieces, e.g. several steaks. This means that several pieces to be cooked are detected at the same time, if present.

The control unit may be designed so as to issue the signals according to times provided in the cooking path, e.g. 2 minutes after the start of the cooking process, or according to the core temperatures and/or surface temperatures determined, for example, via core temperature sensors or the external sensor system.

Particularly when meat is roasted, it is important to turn it at the right time. The turning process itself is checked by the method according to the disclosure to rule out the possibility of the operator only picking up the cooking product but putting it down again on the same side.

The method can also determine whether the correct one of several pieces to be cooked has been turned.

In addition, the cooking product is monitored by the sensor system and the detection device during the cooking method. This means that the cooking product which has already been recognized and detected previously must also be automatically recognized again after the turning process. This is achieved by the method according to the disclosure using the sensor system and the detection device. Optionally, the turned cooking product can be identified by identifying a mirror image of the cooking product before it is turned. It is then monitored further.

Furthermore, the cooking product can be detected by the sensor system during roasting, for example permanently, and the roasting progress can thus be continuously determined. Depending on the roasting progress, the supply of heat is changed and/or the time at which at least one of the signals for moving the cooking product is issued is adjusted.

During the turning process, the detection device does not have to detect the cooking product permanently or at all; rather, it is sufficient to detect the result of the turning process and thus determine whether the turning process has been carried out correctly or incorrectly and where the cooking product was deposited afterwards.

Variants of the method therefore provide that detection occurs either at short, fixed time intervals during roasting or permanently, but that detection is interrupted during the turning process, which is also recognized as such by the detection device.

The detection device may be a separate control unit or be integrated into the control unit for the cooking method.

If the contact heating surface is composed of a plurality of adjacent heating zones which can be controlled independently of each other, the method according to the disclosure optionally provides that the position of the cooking product(s) with respect to the heating zones is determined by means of the sensor system and the detection device.

In this context, a signal for moving the cooking product and for improved positioning of the cooking product can be issued if the cooking product extends over an unnecessarily large number of heating zones. This improves the quality of the cooking method on the one hand and saves energy on the other hand.

The improved position to be aimed at can be output on a screen of the cooking appliance, and/or a direction of movement leading to the improved position can be displayed, which can also be done on a screen.

According to the disclosure, the movement of the cooking product and/or the new position of the cooking product is detected by the sensor system, and a signal is issued if the improved position has not yet been reached or as soon as it has been reached.

If a cooking product protrudes minimally into an adjacent heating zone, this may be tolerated without a signal being issued to change the position of the cooking product. The method provides that an edge tolerance is stored, which tolerates an edge-side overlapping of the cooking product onto an adjacent heating zone such that no signal is issued if the cooking product extends within an edge tolerance area of the adjacent heating zone.

This tolerance area can preferably be between 5 and 15% of the length dimension of the assigned heating zone in the corresponding direction of extension.

As already mentioned, position tracking may be interrupted during a movement of the cooking product as the movement of a hand or a tool in front of the cooking product is complex for the sensor system and the detection device. The interruption reduces the amount of data, and the method can be implemented more stably with this option. However, as the cooking product is individual and can be clearly recognized after it has been moved, this interruption is in no way detrimental to the quality of the method.

If the cooking product is moved out of the sensor area, the cooking path assigned to the cooking product can optionally be closed in the control unit.

The sensor system comprises at least one camera. Optionally, this may comprise one or more of the following sensors: an RGB sensor, an IR sensor and a depth sensor such as a lidar sensor or a ToF sensor. The latter can be used to determine information inside the cooking product.

One variant provides that a light marking projector laterally above the contact heating surface projects light markings, for example lines, onto the cooking product, and at least one sensor, which is positioned laterally above the contact heating surface and laterally away from the light marking projector, detects the light markings projected onto the cooking product, and cooking product properties are determined on the basis of data in the control unit acquired by the at least one sensor.

The light marking projector can project light markings, i.e. a predetermined, for example evenly distributed pattern, onto the contact heating surface and thus onto the cooking product. As has been shown, by limiting the light emitted by means of light strips or, more generally speaking, light patterns, a high level of data accuracy is possible despite the above-mentioned problematic external influences. This above-mentioned projection allows a very comprehensive determination of the properties of the cooking product, e.g. its dimensions and the degree of cooking or its cooking state, by means of the evaluation electronics due to the projected light pattern appearing on the cooking product in a non-linear or different (offset or distorted) pattern.

The pattern itself may be irregular so that the spatial position can also be determined based on the locally individual pattern characteristic. For example, strips could have small, individual bulges which define a coordinate. However, these stripes are evenly distributed.

Numerous light markings, possibly also intersecting light strips, can be projected onto the contact heating surface and thus on the cooking product placed there. This means that the entire contact heating surface is covered with spaced light markings (i.e. a light pattern).

The light marking projector may optionally be a strip projector. The distance between the light markings on the projected surface is preferably less than 5 mm to obtain precise 3-dimensional location and volume information.

The method may be simplified if the sensor or a further sensor optically detects the cooking product without light markings and the acquired data with and without light markings are compared in the evaluation unit, and data as to the three-dimensionality of the cooking product are determined based thereon. In simple terms, the image contents with and without projected lighting are subtracted from each other to obtain the pure image contents from the light marking projection. This allows three-dimensional information to be determined very reliably and accurately. Furthermore, the sensor effort is reduced. The three-dimensional shape, including the caliber of the cooking product, can thus be determined very accurately.

It may be sufficient to use just one sensor.

If data with and without light markings are determined, the cooking product can be detected alternately with and without light markings by at least one sensor, for example at intervals of less than 0.5 seconds or even 0.2 seconds. Among others, this has the advantage that when the light is minimally recognized by the user, the user is not disturbed by the brief activation of the light markings. Furthermore, the short time sequence ensures that the situation on the contact heating surface and the surface of the cooking product is identical for both measurements, i.e. that the food has not been recognizably cooked further and has not been moved or removed.

The time sequences of such alternating scanning processes may be several seconds, i.e., for example, data with and without light markings are always acquired at a short frequency after 10 seconds for less than one second, for example. On the one hand, this reduces the amount of data and, on the other hand, the potential disturbance to the user due to the light markings, which may be barely recognizable.

An additional, simple sensor which is independent of the camera system, for example based on time-off-light or radar, may serve to start scanning of the cooking area using the above-mentioned system sensor in the event of changes in the area of the cooking appliance through operator intervention.

To be able to adjust the spectrum of light used more precisely, one or more optical filters can be used in front of the detecting sensor to reduce the radiation spectrum outside the detection wavelength.

For example, the light marking projector can emit infrared light strips or infrared light patterns in the near-IR spectrum, preferably with a wavelength in the range of 800-1000 nm.

This spectral range is barely visible or invisible to the human eye. It has also been shown to be advantageous in vapor environments.

Additionally or alternatively, light patterns having a visible wavelength in the range of 400-800 nm are generated.

The projected light markings may represent a temporally constant or temporally variable, predefined pattern.

An additional improvement in the data results can be achieved in that the light marking projector also emits infrared light strips or infrared light patterns having a wavelength in the range of 3-4 μm (i.e. in the far-IR spectrum) and the at least one sensor or a further sensor detects these light markings on the cooking product. To be able to detect the entire contact heating surface using a camera or just one sensor, an optically distorting (aspherical) lens, e.g. made of plastic, can optionally be used, which is positioned in front of the preferably singular sensor. Alternatively, an aspherical mirror may be provided in the optical beam path, which corrects the geometric distortion caused by the camera positioning. A data image field corrected optically in this way may also be prepared numerically as a basis for further data processing.

Furthermore, the disclosure relates to a cooking appliance having a control unit programmed to carry out the method according to the disclosure.

The cooking appliance has a contact heating surface to be heated and a housing edge surrounding the contact heating surface, and a tube attached on the side of the cooking appliance and projecting upwards, to which at least one optical sensor is fastened, the cabling of which runs inside the tube to an evaluation electronics accommodated on or in the cooking appliance.

Attaching the sensor to the cooking appliance via the tube ensures both stable and simple positioning of the sensor above and laterally to the contact heating surface to scan it laterally from above and thus enable 3-dimensional detection of the cooking product surface. It is also important that the tube permits an easy cleaning and that the vapors do not constitute a permanent problem for data acquisition or put a strain on the cabling or contacts.

The evaluation electronics may be arranged next to the contact heating surface, i.e. laterally spaced apart therefrom.

The sensor and the tube are preferably provided in a corner region, more specifically in a rear corner region of the housing edge.

However, this tube can alternatively also be offset from the roasting surface and attached to a control unit which is laterally mechanically connected to the contact heating surface, more specifically to the housing of the control unit. The greater distance from the fumes, temperature and vapors generated during the cooking process reduces the environmental impact and the likelihood of contamination of the tube unit.

A light marking projector may be connected on the cooking appliance side, for example firmly connected to the housing edge and spaced apart from the at least one sensor.

The light marking projector is attached either to or in the same tube but laterally offset from the sensor, or to or in another tube attached on the cooking appliance side and projecting upwards, for example a tube on the opposite edge region or opposite corner region.

### BRIEF DESCRIPTION OF THE DRAWINGS

FIG. 1 shows a top view of a cooking appliance according to the disclosure for executing the method according to the disclosure,

FIG. 2 shows a top view of the cooking appliance according to FIG. 1 with the cooking product placed thereon,

FIG. 3 shows a flow diagram of a variant of the method according to the disclosure, and

FIG. 4 shows a perspective view of a cooking appliance according to the disclosure for executing the method according to the disclosure.

### DETAILED DESCRIPTION

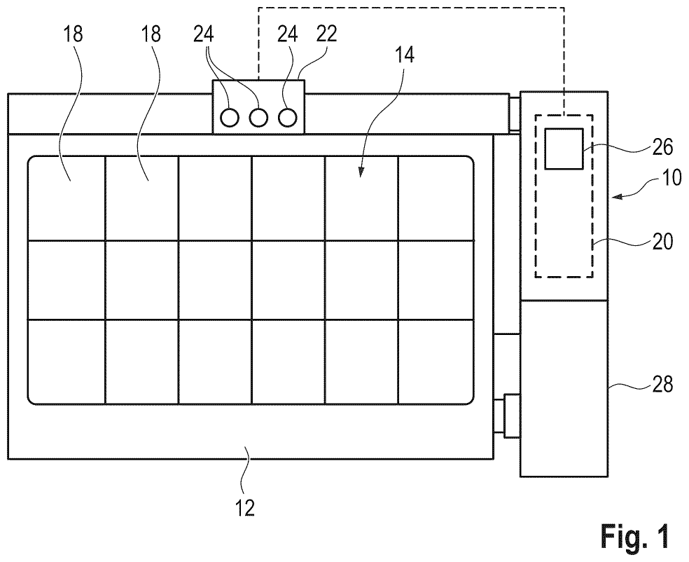

FIG. 1 shows a cooking appliance 10 having a pan 12 the bottom of which forms a contact heating surface 14 which is composed of a plurality of heating zones 18 arranged in rows and columns, each heating zone 18 having one or more heating elements assigned only thereto, for example electrical resistance heating plates below or integrated into the bottom.

These heating elements are connected to a control unit 20 of the cooking appliance 10, which activates the heating elements and controls cooking processes.

For this purpose, several cooking paths are stored in the control unit 20, which are activated or automatically selected depending on the cooking product and the desired degree of cooking.

A sensor system 22 including one or more sensors 24, which optically detect the contact heating surface 14 and the cooking product located thereon, is arranged above the contact heating surface 14.

The sensor system 22 is coupled in terms of signaling to a detection device 26, which may be separate from the control unit 20 or may be integrated thereinto and is also referred to as the evaluation electronics.

FIG. 1 also shows a screen 28 in the form of a touchscreen, via which signals are displayed or data or commands can be entered.

The sensors 24 are cameras, wherein these can comprise one or more RGB sensors, IR sensors and/or depth sensors, for example lidar sensors or ToF sensors.

Preferably, several of these different sensors can be used to utilize their advantages when detecting a cooking product and the properties thereof and to generate image data.

For example, image data for recognizing the contour of the cooking product are generated via the IR sensor(s). The RGB image data from the corresponding sensor(s) can then be used for the product recognition itself. Finally, the depth sensor(s) provide(s) information about the temperature inside the cooking product.

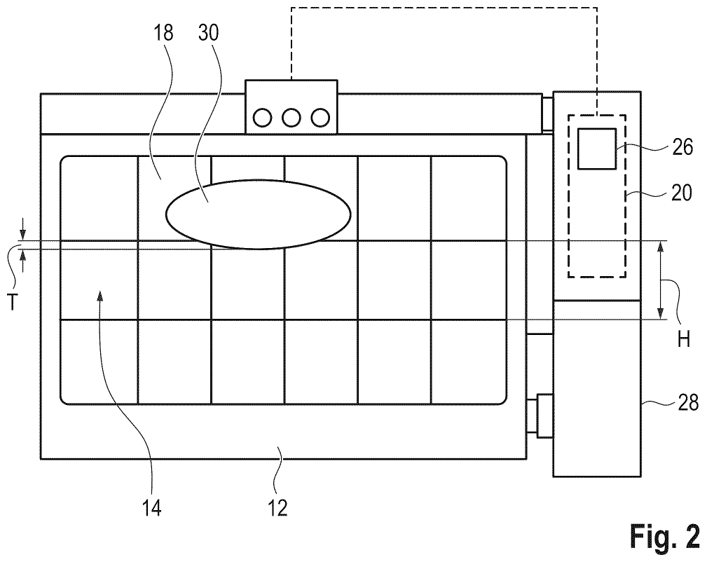

When the cooking product is placed on the contact heating surface 14, the cooking product 30 covers one or more heating zones 18 (see FIG. 2).

The sensor system 22 is used to determine on which heating zones 18 the cooking product 30 is placed.

The cooking product is individualized by its size, shape and possibly also by its color or color shades and is assigned an identifier, e.g. an identification number, in the detection device 26 via the running program, which the cooking product keeps until it is fully cooked and removed. These individual data are determined by the sensor system 22 in conjunction with the detection device 26.

The sensor system 22 and the detection device 26 can also be used to automatically determine the cooking product, i.e. the type of cooking product involved is determined, for example beef, turkey or a type of vegetable or sliced potatoes.

Geometric data, the contour and image data are used for this product recognition for this identification number, i.e. for this individual cooking product.

Once the cooking product has been recognized, an assigned cooking path stored in the control unit 20 for this cooking product, for example roasting the steak medium, starts preferably automatically.

If the recognition process is not successful, for example because the food in question has not been stored in the control unit or has not been stored with a suitable cooking process, the operator can select a correct recipe or a stored cooking process when prompted via the control unit 20. The cooking path for this cooking product is then started.

The cooking path includes, among other things, the roasting temperature leading to the desired result and the definition of control-relevant parameters such as the time or the core temperature, these being only examples.

If, as in FIG. 2, the cooking product 30 is not optimally positioned in relation to the heating zones 18 (in this case it would have to be moved further up), this is automatically detected by the sensor system 22 and the electronic detection device 26 connected thereto.

A signal for moving the cooking product 30 upwards is then issued on the screen 28, or the direction of movement in which the cooking product 30 must be moved until it is optimally positioned is displayed, for example by an arrow pointing upwards.

During this movement process, a signal can also be issued if the improved position has not yet been reached or as soon as it has been reached.

Since heating zones 18 cannot be completely thermally insulated from each other, a position is still acceptable even if the cooking product 30 slightly overlaps on the edge side on a less or not at all electrically heated heating zone 18.

In this case, no signal to move the cooking product 30 is issued as long as the cooking product 30 extends within an edge tolerance area T of the adjacent heating zone 18.

The edge tolerance area T is shown in FIG. 2 and is preferably between 5 and 15% of the length dimension L of the assigned heating zone 18 in the corresponding direction of extension, here in FIG. 2 in the vertical direction.

After positioning of the cooking product 30 has been carried out and, if necessary, optimized, the corresponding cooking path is called up and the cooking product 30 is roasted by heating the heating zones 18 further, if necessary.

During this roasting process, the cooking product 30 is permanently detected by the sensor system 22, and the roasting progress is monitored and determined. The heat supply is changed depending on the roasting progress or in accordance with the cooking path.

According to a time specification or a core temperature, which can also be determined via the sensor system 22, the detection device 26 issues a signal for moving the cooking product 30, first for turning the cooking product 30 by an operator.

The operator can be an operating person or an automatic handling unit.

The screen 28 displays which cooking product 30 needs to be turned.

The turning process is recognized and optionally also monitored. If necessary, the hand of an operator or a turning tool can be recognized. Alternatively or additionally, turning can be detected by using the mirror image of the cooking product 30 before or after turning to then determine the outer geometry of the turned cooking product 30 and recognize the turned cooking product 30. The position tracking of the cooking product 30 can be interrupted during the turning process.

In addition, a signal for removing the cooking product 30 can also be issued, the associated cooking path being then closed when the cooking product 30 has been moved out of the sensor area, which in turn was detected by the sensor system 22.

Furthermore, a signal for chopping the cooking product 30 or adding additional cooking product 30 can be issued.

In addition to the checking of the successful turning by means of the mirror image of the cooking product, it is additionally also possible to use the change in browning and/or the surface temperature for identifying the previously resting side of the cooking product 30.

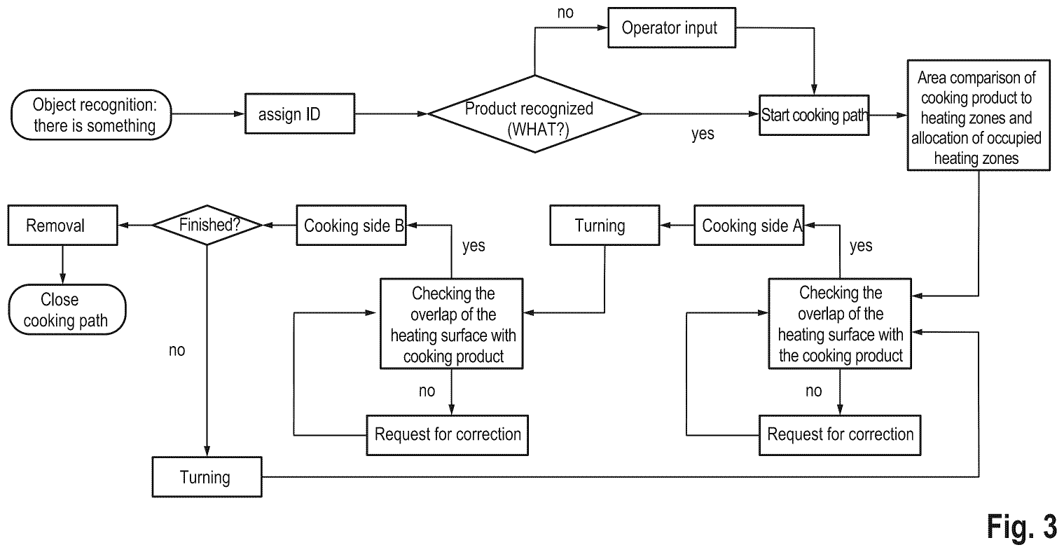

FIG. 3 summarizes the individual steps executed in the control unit 20 and/or in the detection device 26 and explained in more detail above.

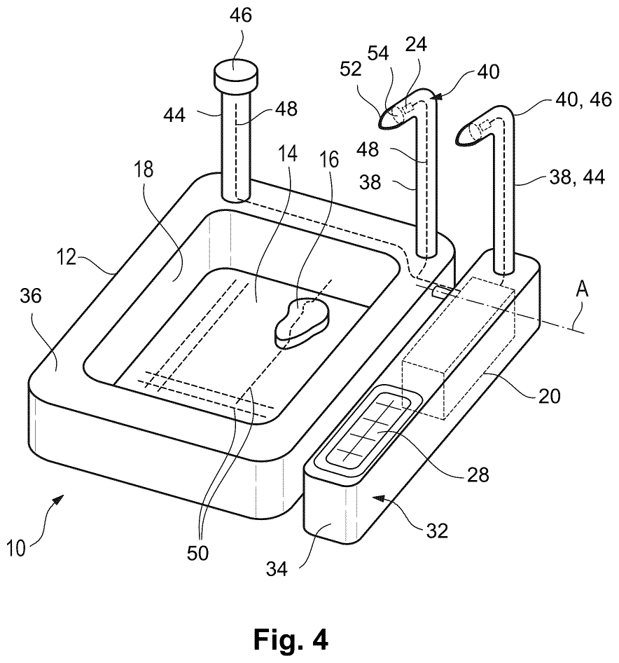

FIG. 4 shows that the pan 12 can be pivoted about a pivoting axis A, preferably by a motor, so that the front edge can be lowered.

The pan 12 is mounted on a base part 32, on the upper side of which the screen 28 is also located. The control unit 20 along with the detection device 26 is housed in the base part 32, more specifically in the housing 34 thereof.

A tube 38 on which a camera 40 having one or more optical sensors 24 is provided in the region of its upper end, is attached to a corner region of the housing edge 36 of the pan 12.

In the opposite corner region, also in the rear section of the housing edge 36, a second tube 44 is provided, which supports a light marking projector 46 which is for example a strip projector. This light marking projector 46 can be located on or in the tube 44.

Alternatively, a crossbar is attached to the tube 38, so that the light marking projector 46 and the camera 40 can be mounted spaced apart from each other.

The cabling 48 of the camera 40 and the light marking projector 46 each extend through the interior of the tube and through a chamber below the housing edge 36 to the detection device 26.

Alternatively, the tube 44 or the tube 38 along with the devices fixed thereto can also be mounted on the control unit, more precisely on the housing 34 thereof, preferably at the upper rear edge section near the rear corner region of the housing edge 36 (cf. tube 38, 44 on the far right in FIG. 4). If the control unit is not accommodated in the housing 34 shown, but elsewhere, the housing 34 is still present as it supports the pan 12. In this case, the tube 38 and/or 44 is optionally fastened to the housing 34 of the base part 32.

The light marking projector 46 is adapted to project preferably parallel, minimally spaced apart light patterns or light markings 50, for example in the form of strips on the entire contact heating surface 14, of which only some are represented by way of example to maintain clarity.

The projected light markings 50 form a temporally constant or temporally variable defined pattern. This pattern can be an optically evenly distributed pattern. Optionally, if light strips are used, these can not only run in parallel, but also crosswise, as outlined.

Some of the light markings 50 or all light markings 50 are light markings with a wavelength of the light in the range of 800-1000 nm or 400-800 nm.

These light markings 50 can additionally also comprise light having a wavelength in the range of 3-4 μm, or there may be other light markings which are defined by light in this other IR frequency range.

The light of the light markings 50 is preferably detected exclusively by the camera 40, and here preferably only by a sensor 24, wherein this is not to be understood in a restrictive way. Alternatively, it is possible to provide a plurality of different sensors in the camera 40.

To ensure that only light in this near-IR range or in both IR ranges reaches the sensor(s) 24, one or several infrared filters 52 are provided upstream of the sensors 24 or downstream of the light marking projector 46.

If the sensor(s) 24 cannot detect the entire contact heating surface, an optically distorting lens 54 may for example be attached directly in front of the sensor(s) 24, via which light can then be detected by the sensor(s) 24 on the entire contact heating surface 14.

The singular sensor 24 is or the several sensors 24 comprise a TOF sensor. The latter can optionally not only provide distance information, but also allow the creation of a monochrome image of the situation on the contact heating surface 14.

In addition, it is of course also possible to use other optical sensors which may possibly also provide color information and thus allow conclusions to be drawn about the degree of browning of the cooking product 16.

Furthermore, a temperature sensor and/or a radar sensor may also be present.

Using the data acquired by the sensor(s) 24, the detection device 26 determines properties of the cooking product, for example it is possible to determine the type of the cooking product 16 itself, the cooking state thereof, the position of the cooking product on the contact heating surface 14, the temperature of the cooking product 16 and/or the caliber of the cooking product 16. For example, this is realized by a statistical evaluation and/or an evaluation using artificial intelligence.

The information obtained makes it possible to control the cooking process, to give commands to the user, or also to indicate operating errors.

The caliber of the cooking product 16 is detected very accurately due to the lateral arrangement of the camera. This is achieved by the combination of a 3-dimensional sensing by means of the perspective shifting of the light markings and the evaluation thereof and visual image detection.

The quality of the data can be improved in that the sensor(s) 24 not only acquire data when light markings 50 are projected, but also when data are acquired without light markings 50, which are compared with the data with light markings 50. To separate these different measurement situations, the projection of the light markings 50 is switched off or prevented, and during this time, the contact heating surface 14 and the surface of the cooking product 16 are detected. Shortly afterwards, light strips or, more generally, light markings 50 are projected again, and the contact heating surface 14 and the surface of the cooking product 16 are detected again using these light markings.

The time interval between these two different measurements may be less than 0.5 seconds, for example less than 0.2 seconds. In simplified terms, the image contents thus detected are subtracted from each other to calculate three-dimensional information as to the surface structure and thus the dimensions of the cooking product 16, the thickness thereof, among other things.

1. A method of roasting a cooking product by a contact heating surface of a cooking appliance, comprising the following steps:
determining a cooking product to be roasted placed onto the contact heating surface by at least one sensor system located above the contact heating surface and an electronic detection device connected thereto,
providing the cooking product with an identifier upon initial placement, the identifier being stored in terms of control,
roasting the cooking product by the supply of heat via the contact heating surface, a control unit of the cooking appliance controlling the amount of the supplied heat in accordance with a cooking product-specific cooking path provided in a control unit as a function of the determined cooking product,
tracking the position of the cooking product via the sensor system during roasting, and
issuing at least one signal to an operator via the control unit, that the cooking product needs to be moved.

2. The method according to claim 1, wherein a signal is a signal for turning, removing, chopping, adding additional cooking product or shifting the cooking product.

3. The method according to claim 1, wherein a signal is a signal signalizing the end of the roasting process.

4. The method according to claim 2, wherein the signals are issued in accordance with times provided in the cooking path or the determined cooking product temperature.

5. The method according to claim 2, wherein a turning process is detected by the sensor system and the detection device and the turned cooking product is detected as turned.

6. The method according to claim 2, wherein the cooking product is detected by the sensor system during roasting, and the roasting progress is thus determined, and wherein the supply of heat is modified and/or the time of the issue of at least one of the signals is adjusted, both depending on the roasting progress.

7. The method according to claim 1, wherein the contact heating surface is composed of a plurality of adjacent heating zones which are adapted to be controlled independently of each other, the position of the cooking product or the position of the cooking product with respect to the heating zones being determined by the sensor system and the detection device.

8. The method according to claim 7, wherein a signal for moving the cooking product and an improved positioning of the cooking product is issued if the cooking product extends over an unnecessarily large number of heating zones.

9. The method according to claim 8, wherein the improved position to be aimed at is output on a screen of the cooking appliance and/or a moving direction leading to the improved position.

10. The method according to claim 8, wherein the movement of the cooking product and/or the new position of the cooking product is detected via the sensor system and a signal is issued if the improved position has not yet been reached or has been reached.

11. The method according to claim 8, wherein an edge tolerance is stored which tolerates an edge-side overlapping of the cooking product on an adjacent heating zone such that no signal is issued if the cooking product extends within an edge tolerance area of the adjacent heating zone.

12. The method according to claim 11, wherein the edge tolerance area is between 5 and 15% of the length dimension of the associated heating zone in the corresponding direction of extension.

13. The method according to claim 1, wherein the position tracking of the cooking product is interrupted during a movement recognition.

14. The method according to claim 1, wherein the cooking path assigned to the cooking product is closed when the cooking product is moved out of the sensor area.

15. The method according to claim 1, wherein the sensor system comprises at least a camera, an RGB sensor, an IR sensor and/or a depth sensor such as a lidar sensor or a ToF sensor.

16. The method according to claim 1, wherein a light marking projector laterally above the contact heating surface projects light markings on the cooking product and at least one sensor which is positioned laterally above the contact heating surface and laterally away from the light marking projector detects the light markings projected onto the cooking product, and cooking product properties are determined based on data in the control unit acquired by the at least one sensor.

17. The method according to claim 16, wherein the light marking projector generates light markings having a wavelength in the range of 800-1000 nm and additionally also emits infrared light strips with far infrared light, and the at least one sensor or a further sensor detects these infrared light strips.

18. The method according to claim 1, wherein the sensor or a further sensor detects the cooking product optically without light strips, and wherein the acquired data with and without light markings are compared in the control unit and data as to the three-dimensionality of the cooking product are determined based thereon.

19. The method according to claim 1, wherein the cooking product is detected alternately with and without light markings by the at least one sensor.

20. A cooking appliance comprising a control unit programmed so as to carry out the method according to claim 1.
